(19) United States
(12) Patent Application Publication
(10) Pub. No.: US 2008/0235728 A1
(43) Pub. Date: Sep. 25, 2008

(54) BROADCASTING RECEIVING APPARATUS, AND METHOD FOR EXECUTING APPLICATIONS IN BROADCASTING RECEIVING APPARATUS

(75) Inventor: Hyo Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/018,908

(22) Filed: Jan. 24, 2008

(30) Foreign Application Priority Data
Mar. 23, 2007 (KR) 10-2007-0028872

(51) Int. Cl. G06F 3/00

(52) U.S. Cl. 725/39

(57) ABSTRACT

Provided are a broadcast receiving apparatus, and a method for executing an application in the broadcast receiving apparatus. The broadcast receiving apparatus includes: a controller which assigns a channel number of the broadcast receiving apparatus to an application; a storage unit which stores the channel number; a user input unit which receives a user input signal; and a communication unit which controls data transmission or reception through an interactive communication network, wherein, if the user input signal selects the channel number, the controller executes the application. Accordingly, by utilizing the broadcast receiving apparatus, users can easily access services which are provided through an interactive communication network.

### CROSS-REFERENCE TO RELATED PATENT APPLICATION

This application claims priority from Korean Patent Application No. 10-2007-0028872, filed on Mar. 23, 2007, in the Korean Intellectual Property Office, the disclosure of which is incorporated herein in its entirety by reference.

### BACKGROUND OF THE INVENTION

1. Field of the Invention

Apparatuses and methods consistent with the present invention relate to executing applications in a broadcast receiving apparatus, and more particularly, to executing applications in the broadcast receiving apparatus by assigning a channel number to each of the applications.

2. Description of the Related Art

In the analog broadcasting age, data transmission meant transmission of a limited amount of letters, but, in the current digital broadcasting age, a variety of services, such as emails, electronic program guides (EPGs), television (TV) banking, telephone services, Internet search services, as well as services of providing information, such as weather, news, etc., are being provided through a TV receiver. As such, data broadcasting has been developed to provide a variety of new services, with the development of related applications. However, although recently a variety of services are being provided by communication through an interactive network such as the Internet, users are still not accustomed to a user interface environment which is newly provided to receive services through an interactive network because they are still accustomed to existing user interface manipulations for selecting or changing broadcast channels.

### SUMMARY OF THE INVENTION

The present invention provides a method and apparatus for easily executing applications by assigning a channel number to each of the applications.

According to an aspect of the present invention, there is provided a broadcast receiving apparatus including: a controller assigning a channel number of the broadcast receiving apparatus to each of at least one application; a storage unit storing the channel number assigned to each application; a user input unit receiving a user input signal; and a communication unit controlling data transmission/reception through an interactive communication network, wherein, if a user input signal for selecting a specific channel number from among assigned channel numbers is received, the controller executes an application corresponding to the specific channel number.

The controller generates mapping information by assigning each channel number to location information indicating a location at which each application is stored.

The controller assigns a channel number to a type of each application and location information indicating a location at which a corresponding application is stored according to the type of each application, thereby generating mapping information.

The communication unit accesses a web server from which an application of the at least one application is capable of being downloaded, and downloads a corresponding application from the web server.

The broadcast receiving apparatus further includes an output unit outputting a screen on which an application of the at least one application is executed.

The controller constructs a screen on which the channel number for an application of the at least one application is provided together with broadcast information.

When the controller executes an application of the at least one application, the application fetches predetermined data from a server connected through an interactive communication, on the basis of control information included in the application.

The controller assigns a channel number of the broadcast receiving apparatus to each application, according to a user's input signal.

The channel number assigned to an application of the at least one application is deleted or changed according to a user's input signal.

The broadcast receiving apparatus further includes a remote controller receiver receiving a signal from a remote controller, wherein the controller executes an application corresponding to a channel number which is transmitted by the signal received through the remote controller receiver.

According to another aspect of the present invention, there is provided a method of executing an application which operates in a broadcast receiving apparatus, including: assigning a channel number of the broadcast receiving apparatus to each of at least one application; and if a user's input signal for selecting a specific channel number from among assigned channel numbers is received, executing an application corresponding to the specific channel number.

### BRIEF DESCRIPTION OF THE DRAWINGS

The above and other aspects of the present invention will become more apparent by describing in detail exemplary embodiments thereof with reference to the attached drawings, in which:

FIG. 1 is a block diagram of a broadcast receiving apparatus according to an exemplary embodiment of the present invention;

FIG. 2 is a table representing location information of applications corresponding to channel numbers, according to an exemplary embodiment of the present invention;

FIG. 3 is a flowchart of a method of executing an application in the broadcast receiving apparatus, according to an exemplary embodiment of the present invention;

FIG. 4 is a flowchart of a method of assigning a channel to each application in the broadcast receiving apparatus, according to an exemplary embodiment of the present invention; and

FIGS. 5A through 5C illustrate screens that are provided through the broadcast receiving apparatus.

### DETAILED DESCRIPTION OF EXEMPLARY EMBODIMENTS

Hereinafter, exemplary embodiments of the present invention will be described in detail with reference to the appended drawings.

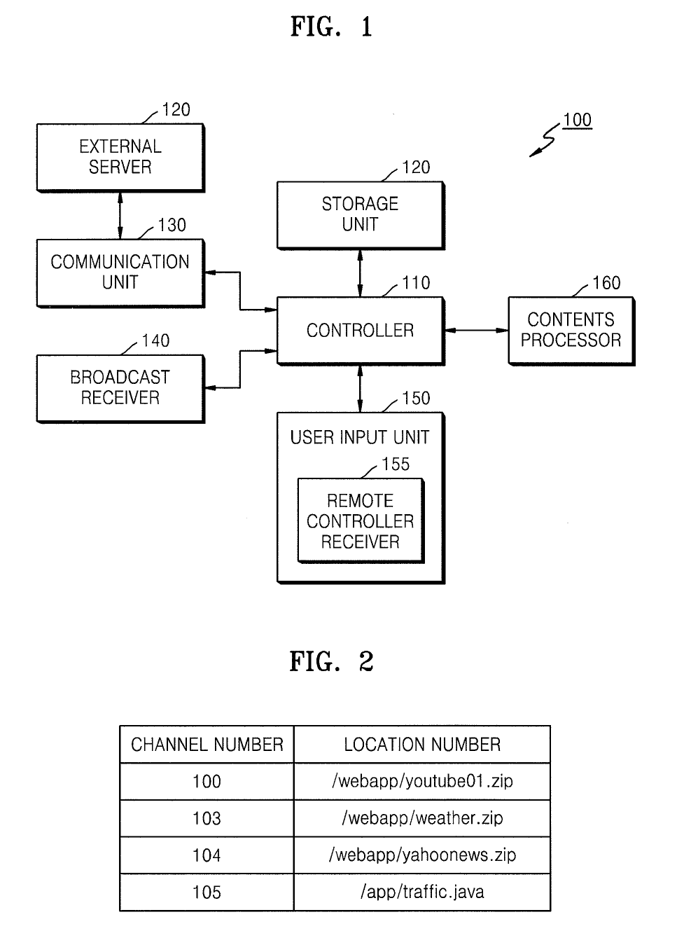

FIG. 1 is a block diagram of a broadcast receiving apparatus 100 according to an exemplary embodiment of the present invention. Referring to FIG. 1, the broadcast receiving apparatus 100 includes a controller 110, a storage unit 120, a communication unit 130, a broadcast receiver 140, a user input unit 150, and a contents processor 160.

The broadcast receiving apparatus 100 can be implemented in the form of an Internet Protocol Television (IPTV) and a set-top box, etc., which is connected to a general television and provides communication through an interactive network. The broadcast receiving apparatus 100 can store at least one application that will be executed therein.

In this specification, the application may provide data, media contents, etc. in a variety of methods or formats through the broadcast receiving apparatus 100. The application can be input to the communication unit 130 through an interactive network, or input to the broadcast receiver 140 through a broadcast network. Also, the application may have been previously stored in the broadcast receiving apparatus 100.

Also, each application may be a web application which is created using at least one of Internet technologies, such as Javascript, HyperText Markup Language (HTML), Cascading Style Sheet (CSS), Document Object Model (DOM), Asynchronous JavaScrpt+XML (AJAX), Hypertext Preprocessor (PHP), Flash, and Scalable Vector Graphic (SVG).

Also, each application may be used to provide a variety of services for data broadcasting. For example, an application may be based on the OpenCable Application Platform (OCAP).

Each application can provide data, such as news information, weather information, and traffic information, can function as a search engine, or can be executed in connection to on-line services that provide moving pictures. For example, an application can be provided in the format of a “widget” program which is provided by “Yahoo”.

Also, each application includes screen configuration information for constructing a screen for providing data, and control information for allowing users to selectively download a content which can be acquired through an interactive communication network, according to the purpose of the application, etc.

The controller 110 controls the broadcast receiving apparatus 100 by controlling data transmission/reception between the components of the broadcast receiving apparatus 100. Also, the controller 110 assigns a channel number of the broadcast receiving apparatus 100 to each application, and manages the channel number.

Generally, the channel number means a number which is assigned to allow a user to select a broadcast channel set by a user or set in advance in the broadcast receiving apparatus 100. In the current application, a channel number which is provided for selecting a broadcasting channel is assigned to an application which operates in the broadcast receiving apparatus 100 so that the application is executed in correspondence to the channel number.

The controller 110 assigns a channel number of the broadcast receiving apparatus 100 to each application, automatically or according to a user's input signal. Also, the controller 110 can assign a channel number to each application, or delete/change a channel number assigned to each application, according to a user's input signal.

Also, a user can select a channel number, by using the user input unit 150 which is a user interface device such as a user input button installed in the broadcast receiving apparatus 100, or by inputting a channel number through a remote controller (not shown). For example, the user can select a channel number, by pressing a number button of a key pad which is installed in the user input unit 150 or a remote controller, or by pressing a channel up button or a channel down button of the key pad.

The controller 110 interprets a signal corresponding to an input channel number, determines whether the input channel number is mapped to a broadcast channel, and if the input channel number is mapped to the broadcast channel, controls the broadcast receiver 140 to tune into the broadcast channel. Also, if the input channel number is mapped to a predetermined application, the controller 110 executes the predetermined application mapped to the channel number.

The storage unit 120 stores a variety of media contents, data, and applications for providing media contents or data, which are received through a broadcast network or an interactive network. Each application can be stored in the storage unit 120, according to a predetermined path which has been designated in advance, or according to information for path setting which is stored in the application.

Also, the channel number which is assigned to each application by the controller 110 is stored in the storage unit 120. In order to store the channel number, in the current exemplary embodiment, the controller 110 stores location information indicating locations at which applications are stored, and mapping information generated by mapping channel numbers to the locations of the applications, in the storage unit 120.

The communication unit 130 controls data transmission/reception through an interactive communication network. The communication unit 130 can access an external server such as a web server from which at least one application can be downloaded, and download the at least one application from the external server.

The broadcast receiver 140 receives and processes broadcast signals. The broadcast receiver 140 can include a module for processing broadcast signals that are received through transmission paths such as satellites or cables.

The user input unit 150 receives a user's input signal. The user input unit 150 can further include a remote controller receiver 155 for receiving the user's input signal from a remote controller. The remote controller receiver 155 can be separated from the user input unit 150.

If a user's input signal for selecting a channel number from among assigned channel numbers is received, the controller 110 executes an application corresponding to the selected channel number. Also, the controller 110 executes an application corresponding to a channel number contained in a signal which is received through the remote controller receiver 155.

The contents processor 160 decodes and outputs media contents received through a broadcast network or an interactive network. The broadcast receiving apparatus 100 can further include an output unit (not shown) for providing processed contents or outputting a screen on which the application is executed.

Since the controller 110 constructs and provides a screen for providing channel information on applications, together with broadcast information, a user can select and execute an application, using a general method of inputting a channel number to select a broadcast program.

If the controller 110 executes an application, the application can perform an operation of fetching predetermined data from a predetermined server which is connected through the interactive communication network, on the basis of control information included in the application.

FIG. 2 is a table representing location information of applications corresponding to channel numbers, according to an exemplary embodiment of the present invention.

As illustrated in FIG. 2, the controller 110 of the broadcast receiving apparatus 100 illustrated in FIG. 1 assigns a channel number to location information indicating a location at which each web application of a plurality of web applications is stored, to generate mapping information, and manages the mapping information. The controller 110 searches for the location of an application corresponding to a channel number contained in a user's input signal, using the mapping information, and executes the application positioned at the location.

Alternatively, the controller 110 can assign channel according to the type of each application and location information indicating a location at which each application is stored according to the type of the application, and thus generate mapping information. For example, as illustrated in FIG. 2, in the case of a JAVA application of a digital television which is assigned to a channel number 105, if a storage path of an application set by a middleware of the digital television is “/dtv/app/javaapp” and information included in a JAVA application that is to be downloaded is “/app/traffic.java”, the JAVA application “/app/traffic.java” is added to the predetermined path “/dtv/app/javaapp” set by the digital television's middleware, so that an actual path becomes “/dtv/app/javaapp/traffic.java”.

Accordingly, if the channel number 105 is received, the controller 110 interprets the mapping information to determine whether the channel number 105 corresponds to a JAVA application, reads relative location information such as “app/traffic.java” from the storage unit 120, searches for an application corresponding to the channel number 105 from the storage unit 120, and executes the application.

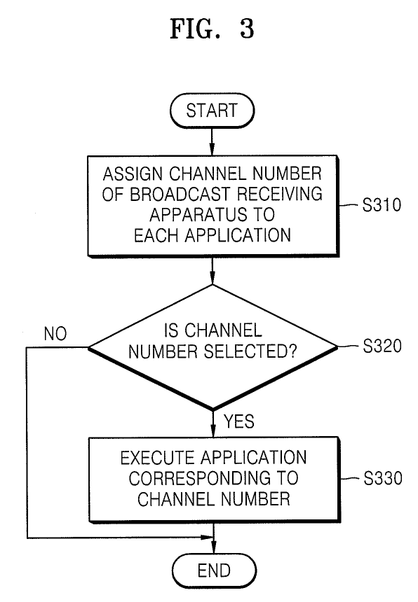

FIG. 3 is a flowchart of a method of executing an application in the broadcast receiving apparatus 100 illustrated in FIG. 1, according to an exemplary embodiment of the present invention.

In operation S310, the controller 110 assigns a channel number of the broadcast receiving apparatus 100 to each of at least one application. The operation S310 can be performed in response to a user's input signal. The channel number assigned to each application can be deleted or changed according to a user's input signal. The application can be downloaded from a web server which provides a download service for the application, or can be received through a broadcast signal. The controller 110 can perform the operation S310, using a method of mapping a channel number to location information indicating the location of a web application stored in the broadcast receiving apparatus 100.

Then, in operation S320, it is determined whether a user's input signal for selecting a channel number from among assigned channel numbers is received. If a user's input signal for selecting a channel number from among assigned channel numbers is received, the controller 110 executes an application corresponding to the channel number in operation S330. The controller 110 can read location information of an application mapped to the channel number from the mapping information, and search for and execute the application on the basis of the location information.

Between the operation 310 and the operation 320, an operation of providing channel numbers corresponding to applications together with broadcast information can further be performed to provide channel information assigned to applications to the user and then receive a channel number as a user's input signal from the user.

The application can perform operation which can be connected to a contents providing server for providing data that is to be provided by the application, to receive contents defined by the application through an interactive communication network, and provide the contents to the user.

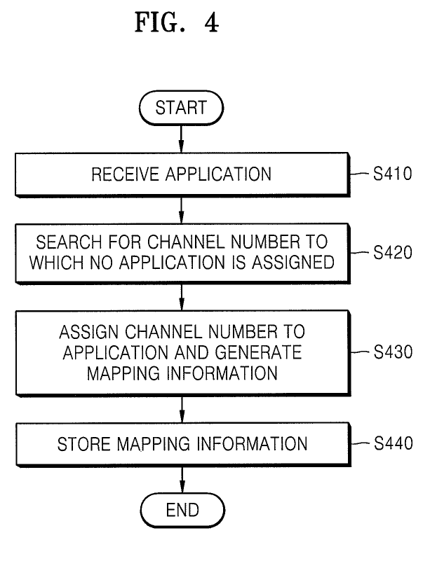

FIG. 4 is a flowchart of a method of assigning a channel number to each application, which is performed by the broadcast receiving apparatus 100 illustrated in FIG. 1, according to an exemplary embodiment of the present invention.

According to the current exemplary embodiment, if a predetermined application is received through a broadcast network or a communication network, a channel number can be automatically assigned to the predetermined application.

In operation S410, an application is received through the communication unit 130 or the broadcast receiving unit 140. The application can be downloaded from an external server such as a web server through an interactive network, or received through a broadcast network.

If an application is received, the controller 110 performs an operation for assigning a channel number to the application. In operation S420, the controller 110 searches for a channel number to which no application is assigned. In operation S430, the controller 110 assigns a predetermined channel number which is decided according to a predetermined rule, to the received application, thereby generating mapping information. The controller 110 can assign a channel number which is a lowest number among channel numbers to which no application is assigned, to location information indicating a location at which the received application is stored, thereby generating mapping information. In operation S440, the mapping information is stored.

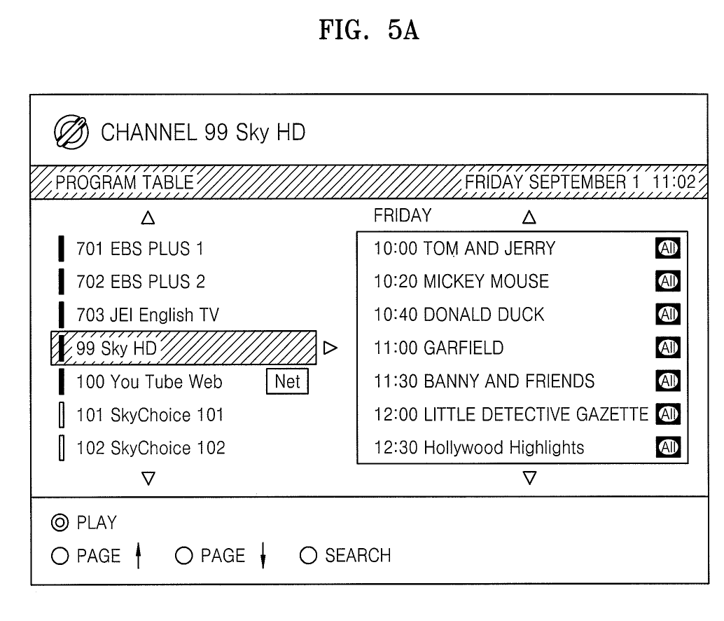

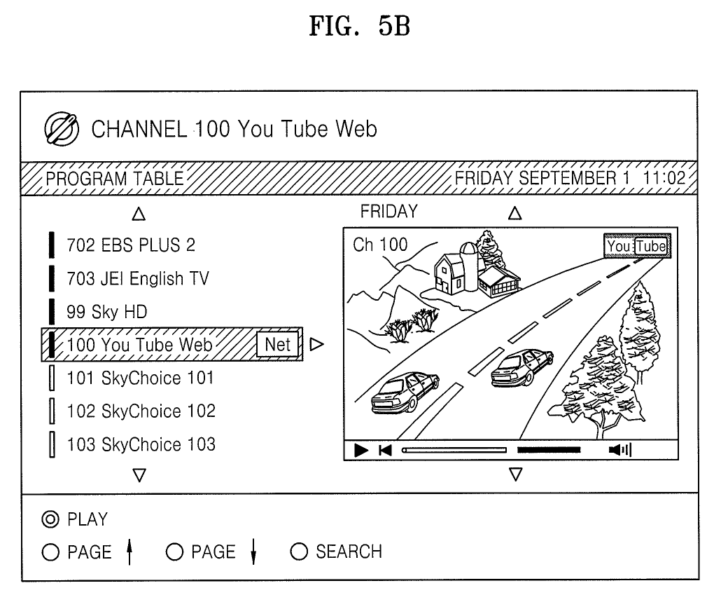

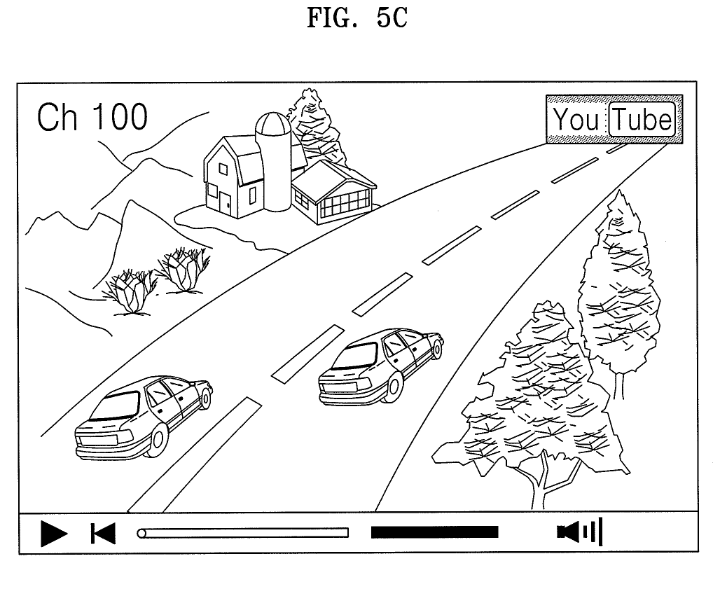

FIGS. 5A through 5C illustrate screens which are provided by the broadcast receiving apparatus 100 illustrated in FIG. 1.

FIG. 5A illustrates a screen on which information on applications and channel numbers assigned to the applications are provided to electronic program guide (EPG) information. By displaying applications together with channel numbers assigned to the applications, a user recognizes the applications as if they are broadcast programs, and accordingly can easily access his or her desired application. In FIG. 5A, information “net” is added to information “You Tube Web” to which a channel number 100 is assigned, so that it can be represented that the channel number 100 corresponds to a web application in contrast to the other broadcast programs.

For example, if the user inputs a channel number 99, broadcast information for a Sky HD channel can be provided as illustrated in FIG. 5A, and the user can receive broadcast programs transmitted through the Sky HD channel by pressing a channel change button. Meanwhile, if the user inputs the channel number 100, the broadcast receiving apparatus checks location information of an application to which the channel number 100 is mapped, and executes an application “You Tube Web” which is positioned at the corresponding location.

FIG. 5B illustrates a screen on which a web application is executed, according to an exemplary embodiment of the present invention.

If a user inputs a channel number and executes an application “You Tube Web”, as illustrated in FIG. 5B, the application “You Tube Web” is executed and provided on a sub screen of an EPG screen. If the application “You Tube Web” is executed, it is possible to access a web server which provides moving pictures using the application “You Tube Application” according to control information included in the application “You Tube Application”, and provide predetermined moving pictures as illustrated in FIG. 5B.

FIG. 5C illustrates a screen on which a web application is executed, according to another exemplary embodiment of the present invention.

The result obtained by executing the web application can be provided as a part of an EPG providing screen as illustrated in FIG. 5B, or as a full screen as illustrated in FIG. 5C. In the screen illustrated in FIG. 5C, a user can select a channel number. In FIG. 5C, if a channel number input by the user is mapped to a broadcast channel, a broadcast program transmitted through the corresponding broadcast channel will be provided. If the channel number input by the user is mapped to a different application, a screen on which the different application is executed will be provided. However, the present invention is not limited to these, and a screen on which the application is executed can be provided in various formats.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

As described above, according to the exemplary embodiments of the present invention, when an application is executed using a broadcast receiving apparatus, the application can be executed using a method which is similar to a related art channel selection method. Accordingly, it is possible to easily access services that are transmitted through an interactive communication network, using an existing apparatus for allowing a user to select a broadcast channel.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A broadcast receiving apparatus comprising:
a controller which assigns a channel number of the broadcast receiving apparatus to an application;
a storage unit which stores the channel number;
a user input unit which receives a user input signal; and
a communication unit which controls data transmission or reception through an interactive communication network,
wherein, if the user input signal selects the channel number, the controller executes the application.

2. The broadcast receiving apparatus of claim 1, wherein the controller generates mapping information by assigning the channel number to location information indicating a location at which the application is stored.

3. The broadcast receiving apparatus of claim 1, wherein the controller assigns the channel number to a type of the application and location information indicating a location at which the application is stored according to the type of the application, thereby generating mapping information.

4. The broadcast receiving apparatus of claim 1, wherein the communication unit accesses a web server from which the application is capable of being downloaded, and downloads the application from the web server.

5. The broadcast receiving apparatus of claim 1, further comprising an output unit outputting a screen on which the application is executed.

6. The broadcast receiving apparatus of claim 1, wherein the controller constructs a screen on which the channel number and broadcast information are provided.

7. The broadcast receiving apparatus of claim 1, wherein, when the controller executes the application, the application fetches data from a server connected through an interactive communication, on the basis of control information included in the application.

8. The broadcast receiving apparatus of claim 1, wherein the controller assigns the channel number according to the user input signal.

9. The broadcast receiving apparatus of claim 1, wherein the channel number assigned to the application is deleted or changed according to the user input signal.

10. The broadcast receiving apparatus of claim 1, further comprising a remote controller receiver which receives the user input signal from a remote controller.

11. The broadcast receiving apparatus of claim 1, wherein the application is an application created using at least one of Javascript, HyperText Markup Language (HTML), Cascading Style Sheet (CSS), Document Object Model (DOM), Asynchronous JavaScrpt+XML (AJAX), Hypertext Preprocessor (PHP), Flash, and Scalable Vector Graphic (SVG).

12. The broadcast receiving apparatus of claim 1, wherein the application comprises screen configuration information for constructing a screen for providing data, and control information for allowing a user to selectively download contents through the communication unit.

13. A method of executing an application which operates in a broadcast receiving apparatus, comprising:
assigning a channel number of the broadcast receiving apparatus to an application; and
if a user input signal for selecting the channel number is received, executing the application.

14. The method of claim 13, wherein the assigning the channel number of the broadcast receiving apparatus to the application comprises assigning the channel number to location information indicating a location at which the application is stored.

15. The method of claim 13, wherein the assigning the channel number of the broadcast receiving apparatus to the application comprises assigning the channel number to a type of the application and location information indicating a location at which the application is stored according to the type of the application, thereby generating mapping information.

16. The method of claim 13, wherein the application is downloaded from a web server which provides a download service of the application.

17. The method of claim 13, further comprising providing a user with the channel number and broadcast information.

18. The method of claim 13, wherein the executing the application comprises fetching predetermined data from a server which is connected through an interactive communication, on the basis of control information included in the application.

19. The method of claim 13, wherein the assigning the channel number of the broadcast receiving apparatus to the application is performed according to the user input signal.

20. The method of claim 13, further comprising deleting or changing the channel number assigned to the application, according to the user input signal.

21. A computer-readable recording medium having embodied thereon a program for executing a method comprising:
assigning a channel number of the broadcast receiving apparatus to an application; and
if a user input signal for selecting the channel number is received, executing the application.
